(19) United States
(12) Patent Application Publication
(10) Pub. No.: US 2007/0208643 A1
(43) Pub. Date: Sep. 6, 2007

(54) System And Method Of Investing Funds

(76) Inventors: Pascal J. Gauthereon, Balgowkal Height (AU); Ashwin Field, New South Wales (AU); Mark L. McDougall, New South Wales (AU); Bennett Chen, New South Wales (AU)

Correspondence Address: ACCENTURE CHICAGO 28164;BRINKS HOFER GILSON & LIONE, P O BOX 10395, CHICAGO, IL, 60610, US

(21) Appl. No.: 10/562,185

(22) PCT Filed: Jun. 28, 2004
(86) PCT No.: PCT/AU04/00859

§ 371 Date: Feb. 1, 2007

(30) Foreign Application Priority Data
Jun. 26, 2003 (AU) 2003903293

(51) Int. Cl. G06Q 40/00

(52) U.S. Cl. 705/36 R

(57) ABSTRACT

In one aspect, the invention provides a data communications network including communication devices enabling communication between a user and a funds investment system, a method of investing funds with asset manager programs by distributing total funds available for investment to a plurality of asset manager programs said distribution effected by performing the method step of performing a plurality of intermediate allocations, each intermediate allocation according with predefined rules supplied to the system by the user over the communications network and repeating the step of performing intermediate allocations until all available funds are allocated with asset manager programs.

### FIELD OF THE INVENTION

The invention relates generally to a system and method of investing funds. More particularly, the invention relates to a system and method of automating an allocation of funds with asset managers in accordance with an investor's instructions. Further, the invention relates to a system and method of automating the analysis and re-distribution of funds in accordance with an investor's required portfolio construction.

### BACKGROUND OF THE INVENTION

Individually Managed Accounts (IMAs) are a custodial investment service in which a professional asset manager manages a portfolio of securities held by an investor (either in the investor's name or through a nominee) or on behalf of the investor. The investor (through an adviser or broker) is able to customise their managed portfolio to meet specific needs or preferences.

IMAs offer the benefits of mutual investment vehicles such as unit trusts by sharing the cost of professional money management with other investors, sharing institutional trading costs and obtaining greater market reach. They include two additional advantages:

1. The investor is a direct holder of the security thereby minimising capital gains, trading costs and cash drag; and

2. For the more complex IMA offerings, the investor is able to customise the portfolio around existing investments (for example, managing actions in their IMA to minimise tax across their total portfolio) and to reflect personal investment or ethical preferences.

IMAs (also sometimes called separate accounts or consultant wraps) currently offered in the market are generally limited to high value accounts as institutions have not been able to manage the conflict between the advantages of personal customisation of asset selection and the costs associated with trading and professional money management. As a result, institutions are not equipped, and hence not able, to offer IMAs to lower net worth customers.

In order to provide investment services that offer the advantages of IMAs to relatively low account value customers, institutions need to be able to provide all of the following features in one cost effective package:
High level of customisation;
Continuous active management by a professional third party;
Accurate tracking of professional management performance; and
Sufficiently low cost in order to be attractive to low value account holders.

For example, some IMAs currently offered in the market have a simple single tiered structure whereby advisers, on behalf of investors, allocate part of an investor's holding to be actively managed by asset managers. These IMAs offer a large amount of customisation while still being actively managed by a professional asset manager. Due to the cost associated with a professional manager, these offerings are only able to be cost effectively applied to high account values. This limitation imposed by IMA providers stems from the requirement to have an asset manager manage these accounts individually through manual means in order to apply the investor's customisation mandate and maintain the required level of performance.

Previous attempts at providing the benefits of IMAs to relatively low account values have been implemented by applying an asset manager's program identically on many accounts simultaneously thereby limiting the level of manual intervention by an asset manager to a minimum. This approach has allowed active management to be performed at low administration cost by applying these programs to hundreds or thousands of accounts at the same time. However in order to maintain a low administration cost, when a conflict arises between an account's customisation mandate and an asset manager's orders, a simple conflict resolution policy is adopted such as the customisation mandate superseding the asset managers orders.

Accordingly, when a high level of customisation is applied to an individual account, the tracking error resulting from customisation mandates superseding the asset manager's orders rapidly increases over time. In effect, the more customisation options offered, the less active the management of the accounts become as there is an increased likelihood that a customisation mandate will supersede an asset manager's orders. As a result, this approach to offering IMAs to relatively low account values has been met with limited success.

Therefore, it is an object of the present invention to provide a more efficient system and method for investing funds and more particularly, a more efficient system and method for delivering the advantages of an investment structure such as an IMA.

### SUMMARY OF THE INVENTION

The present invention attempts to overcome at least one of the problems of the prior art by providing a method of investing funds including the allocation of investment funds to asset manager programs wherein the distribution of total funds available for investment to a plurality of asset manager programs is effected by performing the method steps of performing a plurality of intermediate allocations, each intermediate allocation according with a pre-defined rule established to apportion funds according to an investor's preferred distribution of investment funds to particular assets or classes of assets said allocations forming a network of allocations with intermediate allocations receiving an apportionment of funds from a superior allocation and apportions funds to a subordinate allocation said method step of allocating funds to subordinate allocation being repeated until all available funds are allocated to a most subordinate allocation each most subordinate allocation representing an asset manager program.

Usually, professional asset managers provide investment programs that specialise in a particular asset or class of assets and having received an allocation of funds, the asset manager operating the particular program is able to concentrate upon the task of managing the funds allocated to their program.

The intermediate allocations form a network of allocations. In this network, an intermediate allocation receives an apportionment of funds from a superior allocation and apportions funds to a subordinate allocation. The most subordinate allocation (ie the allocation for which there are no further available subordinate allocations) is an asset manager. Similarly, the most superior allocation is an investor's total investment portfolio.

Intermediate allocations may be grouped to define categories of allocations with the network of intermediate allocations forming a hierarchy of allocation categories. In this instance, an intermediate allocation receives an allocation of funds from a superior allocation category and apportions funds to a subordinate allocation category. In this example, the most subordinate allocation category is an asset manager and the most superior allocation category is an investor's total investment portfolio.

In a preferred embodiment of the invention, the allocation categories are individually managed. This is particularly beneficial as the management of allocation categories does not require the skills and expertise of an asset manager. Accordingly, the cost of managing the allocation categories is substantially less than the cost that would be incurred if this task was performed by a skilled asset manager.

In a particularly preferred embodiment, the method includes the step of receiving from asset managers to whom funds have been allocated, a valuation of the invested funds in each of the asset manager programs. Further, the method includes the step of determining a value at each superior allocation, the value being determined from valuations at subordinate allocations.

The valuation of intermediate allocations may occur sporadically, periodically or as a result of a pre-defined trigger. For example, a valuation may be triggered as a result of the value of invested funds with a particular asset manager program exceeding a pre-defined value.

Further, the valuations of the intermediate allocations may be compared with the pre-defined allocation rules to determine the extent of variance with respect to those rules. In a particularly preferred embodiment, the method includes rules relating to the allowable variance of allocation valuations and the pre-defined rules regarding intermediate allocations. In the event that the allowable variance is exceeded, a warning is provided.

Irrespective of the cause for considering a redistribution of invested funds, the method preferably includes the generation of recommended actions for the distribution of investment funds in order to bring the distribution of funds into agreement with the pre-defined allocation rules again. Preferably, the recommended actions include the provision of recommended buy and sell orders with respect to particular securities. In a particularly preferred embodiment, the method includes the step of providing a simulated valuation of the intermediate allocations and the funds invested with individual asset manager programs that would most likely result from executing the recommended actions.

Preferably, the method is supported by an automated administration process that significantly reduces the requirement for manual intervention with respect to the following administrative tasks:
Application and account establishment;
Re-balancing the distribution of an investor's funds with individual asset manager programs as a result of updated valuations;
Performance review of individual asset manager programs; and
Asset manager program replacement.

Automating any aspect of the administration of the method of investing funds of the present invention assists in reducing the overall cost of operating such a method and enhances the attractiveness of implementing the method for holders of relatively low value accounts.

In another aspect, the present invention provides a method of managing invested funds where funds have been allocated to a plurality of asset manager programs through a plurality of intermediate allocations with each intermediate allocation according with a pre-defined rule, the method including the steps of:
conducting a review of the value of funds held by the plurality of asset manager programs;
calculating the intermediate allocations that would have led to the distribution of funds to individual asset manager programs according to the previously conducted review;
comparing the calculated intermediate allocations with the pre-defined rules for same; and
in the event that a pre-defined variance between the calculated intermediate allocation and the pre-defined rule for same is exceeded, calculating a new allocation of funds to asset managers in accordance with the pre-defined rules for intermediate allocations.

In a preferred embodiment, the requirement to perform a new calculation of funds distribution to asset managers is provided to a user as a warning that action is required to maintain the integrity of the pre-defined intermediate allocation rules. The new calculation of funds distribution may be presented to a user for consideration and preferably, a further calculation is performed to determine the options that are available to effect the new distribution of funds. In a particularly preferred embodiment, the step of selecting an option and effecting the transfer of funds between asset managers is automated.

Conducting a review of the value of funds allocated to asset managers may be on a periodic basis or could be initiated by an event such as a significant change to a stock market index.

In another aspect, the present invention provides a funds investment system for investing funds by allocating those investment funds to a plurality of asset manager programs including:

a data input means enabling an operator to enter data relating to pre-defined rules for a plurality of intermediate allocations of funds and an amount of investment funds available;

a calculating means for determining the amount of funds that should be allocated to each subordinate allocation said determination according to the pre-defined rule associated with each intermediate allocation; and

a data output means for reporting the determined amount of funds that should be allocated to the most subordinate allocations each said most subordinate allocation representing an asset manager program.

In a preferred embodiment, the data input means and the data output means is a personal computer connected to a data communications network the personal computer executing computer instruction code that enables n operator to enter pre-defined rules and receive a report of the distribution of funds that should be effected to accord with those rules. In this embodiment, the personal computers are connected to a data communications network that is also connected to a central computer that acts as the calculating means. In this embodiment, the central computer is sized to accommodate the computing workload of performing calculations for a reasonably large number of accounts. However, in other embodiments, it is not infeasible for a personal computing device to also act as the calculating means. In any embodiment, the data input, output and calculating means could include any one or more of the following:

a laptop personal computer;

a notebook personal computer;

a wireless laptop personal computer;

a wireless notebook personal computer;

a cell phone; or

a cell phone having connection facilities to the data communications network.

In a further aspect, the present invention provides a computer program embodied on a computer readable medium for allocating investment funds to a plurality of asset manager programs wherein said computer program includes computer instruction code for executing tasks including:

code for accepting data relating to pre-defined rules for a plurality of intermediate allocations and an amount of investment funds available;

code for calculating the amount of funds that should be allocated to each subordinate allocation said calculation according to the pre-defined rule associated with each intermediate allocation; and

code for reporting the calculated amount of funds that should be allocated to the most subordinate allocations, each said most subordinate allocation representing an asset manager program.

The code may result in computer instructions that are implemented integrally to a computer or over a network using separate software components. The code may also include components of existing software that effect functions in cooperation with dedicated code developed specifically for the present invention.

In yet another aspect, the present invention provides in a data communications network including communication devices enabling communication between a user and a funds investment system, a method of investing funds with asset manager programs by distributing total funds available for investment to a plurality of asset manager programs said distribution effected by performing the method step of performing a plurality of intermediate allocations, each intermediate allocation according with predefined rules supplied to the system by the user over the communications network and repeating the step of performing intermediate allocations until all available funds are allocated with asset manager programs.

Further benefits and advantages with respect to the present invention become apparent in the following description of a preferred embodiment of the invention.

### BRIEF DESCRIPTION OF THE DRAWINGS

A preferred embodiment of the invention will now be described which should not be considered as limiting any of the statements in the previous section. The preferred embodiment will be described with reference to the following Figures in which:

FIG. 1 illustrates a multi-tier portfolio structure in accordance with one embodiment of the invention comprising four tiers;

FIG. 2 illustrates the application and account establishment process of a preferred embodiment of the invention;

FIG. 3 illustrates a contribution process for increasing the total available funds for investment, the contribution being a cash contribution, according to a preferred embodiment of the invention;

FIG. 4 illustrates a contribution process for increasing the total available funds for investment, the contribution being a securities contribution, according to a preferred embodiment;

FIG. 5 illustrates a rebalancing process according to an embodiment of the invention as applied to a two tier portfolio;

FIG. 6 illustrates a tier-level rebalancing decision path through the various levels of a multi-tiered portfolio according to an embodiment of the invention;

FIG. 7 illustrates a multi-tier rebalancing process according to an embodiment of the invention; and

FIG. 8 illustrates an asset manager performance review process according to a preferred embodiment.

### DESCRIPTION OF PREFERRED EMBODIMENT

In the preferred embodiment of the invention, intermediate allocations subordinate to an investor's portfolio of available funds for investment are viewed as forming a tree structure with intermediate allocations grouped to form “tiers”. In this view of the intermediate allocations, each tier represents all the intermediate allocations residing at a particular depth in the tree structure. The leaf nodes of the tree structure represent the individual asset manager programs to which funds are ultimately allocated depending upon the pre-defined rules that are established for each superior intermediate allocation.

For the purposes of this specification, it should be noted that terminology differences exist across countries with respect to the term “asset manager” which in some countries is referred to as an “asset manager”. Further, the phrase “Individually Managed Account” is sometimes referred to as a “Consultant Wrap” or “Separate Accounts”.

Individually Managed Account Structure

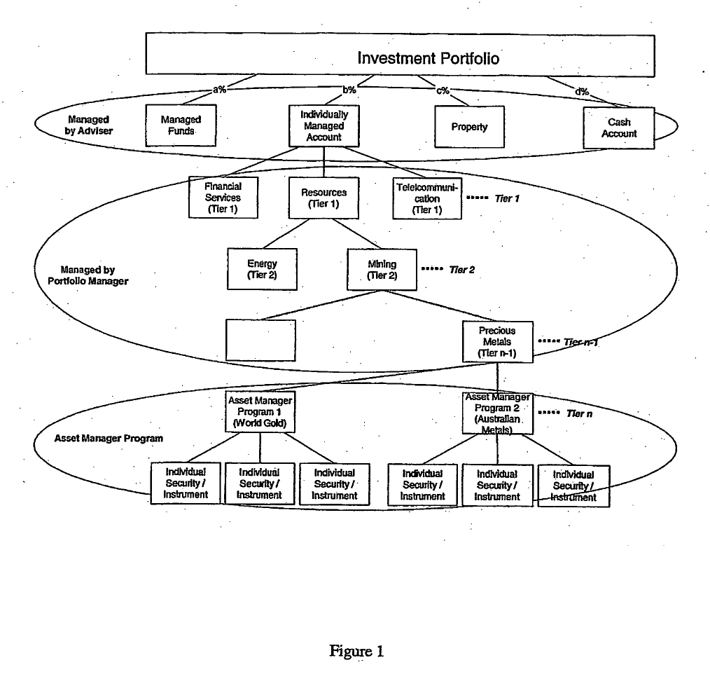

With reference to FIG. 1, an example arrangement of intermediate allocations is detailed wherein a percentage (b %) of an investor's portfolio is allocated to an Individually Managed Account (IMA) according to the present invention.

Of the total available funds for investment, a pre-defined rule is established at the IMA level setting out the investors preferred customisation of distribution of their funds. For example, at the IMA level of FIG. 1, the total funds available for investment are allocated to three classes of asset, namely, Financial Services, Resources and Telecommunications. Although not indicated in FIG. 1, the pre-defined rule at this level could require allocation of 20% of the investor's funds into the asset class of Financial Services and 50% and 30% respectively for the classes of Resources and Telecommunications. The application of this pre-defined rule allows the investor to customise the allocation of their investment funds with respect to primary asset classes.

The primary asset classes are identified as residing in tier 1 of the intermediate allocation tree. Each of the intermediate allocations represented by the primary asset classes in FIG. 1 also includes a pre-defined rule establishing the preferred allocation of funds in that asset class. For example, the asset class of Resources has further allocations of funds to Energy and Mining asset classes. Although not indicated in FIG. 1, the pre-defined rule established for the Resources asset class may require allocation of 50% of funds to that class to each of the subordinate intermediate allocations of the Energy and Mining sub-classes. The Energy and Mining sub-classes are identified as residing at tier 2.

This approach is repeated until all the customisation requirements of an investor are satisfied with all available funds for the IMA distributed to the nth tier comprising individual asset managers (identified as Asset Managers in FIG. 1).

The nth tier comprises individual asset managers who specialise in particular asset classes (eg World Gold and Australian Metals as identified in the example of FIG. 1). The asset managers at this tier then allocate funds according to their own programs to individual securities or instruments depending upon the prevailing economic conditions at the particular time.

With reference to the example structure of FIG. 1, the arrangement of the intermediate allocation of funds may be described as a multi-tiered portfolio arrangement. This particular arrangement enables the customisation options of an investor to be viewed in logical tiers each creating a choice of portfolio allocation options for an investor.

The number of tiers required will depend on the market conditions, but a portfolio could be structured to be of sufficient depth to address all the customisation requirements of an investor. Of course, without a computer program to administer the allocation process, the greater the number of tiers the greater the cost of administering the investment.

In another example, the arrangement of an investment portfolio into tiers could be implemented in four levels as follows:

Asset Classes: Equities based IMAs would represent one asset class, as would cash, property, etc;

Industry groups: representing equities grouped into primary level industry groups such as financial services, telecommunications, industrial, etc;

Sectors asset manager programs: representing equities actively managed by asset managers in programs specialised in secondary level industry groups such as within financial services, banking, insurance, capital markets, etc; and

Equities: these could be listed equities, traded derivatives or other sector related traded instrument.

In another example where more than just equities are managed through IMAs, the multi-tiered arrangement could be used to represent a combination of investment styles and geographies, for example:

Investment styles could be the first tier including styles such as tax optimisation, growth, income, etc;

Continents could comprise the second tier representing the source of the assets managed within the IMA such North America, Asia, Europe, etc;

Country specific asset manager programs representing active asset manager programs that match the selected investment style and where assets reside in the selected country such as Germany, France, Portugal, etc could form the third tier; and

Assets could form the fourth tier representing any assets that an investor could legally own directly such as listed equities, traded derivatives, fixed interest, and property shares.

This multi-tiered allocation of investment funds allows an IMA portfolio to incorporate individual investor's customisation within the multiple tier structure whilst maintaining accurate tracking against asset managers' performances at the nth tier of the arrangement.

Portfolio Management Processes

Defining key active portfolio management processes (such as rebalancing, account creation and general account administration) allows differently skilled third parties to manage each tier thus enabling individual aspects of the management of an IMA to be allocated to the most appropriate class of qualified individuals.

In particular, this approach enables the overall administration cost of managing an IMA to be reduced as compared with arrangements where highly skilled and qualified operators perform tasks that only require relatively low skill and experience to competently execute.

For example, financial advisers may be employed to manage the asset class tier (allocating the total investment portfolio into various asset classes including an IMA), portfolio managers and/or skilled advisers may be employed to manage the industry or sector tiers (allocating the IMA portion of the portfolio to different industry or sector programs run by asset managers) and asset managers may be employed to manage underlying securities/instruments (allocating the portion of the IMA portfolio assigned to their program across various securities according to their industry or asset specialisation).

In a preferred embodiment of the invention, defining the key active portfolio management processes and substantially automating those processes enables cost efficiencies to be realised such that the delivery of a multi-tiered IMA arrangement is sufficiently cost effective to be of value to moderate value accounts.

Administration Processes and Automation

A multi-tiered IMA portfolio structure increases the management and administration complexity significantly. If active management is to be maintained at all tiers, the administration burden to maintain the pre-determined allocation across each tier can become substantial.

Furthermore, the number of asset managers required to make the multi-tiered structure relevant imposes an additional administration burden on an IMA provider.

In addition, as more tiers are introduced, the complexity of managing these tiers is compounded as the impact of changes in the valuation of Tier n impacts the valuation of Tier 1 and may introduce an imbalance in the portfolio at any level.

Achieving a lower cost of administration in a preferred embodiment is realised as a result of streamlining the performance of day-to-day administration tasks.

Defining key processes in order to minimise duplication and appropriately assigning management tasks across to the most appropriate resource assists in the reduction of administration costs. Administration processes have been arranged to minimise the number of steps required to perform a task whilst retaining a sufficient level of definition for the task to be self-explanatory.

Only the key processes relating to the administration of an IMA according to the present invention are described below. Of course, as will be clearly recognized by those skilled in the art, various additional processes are required in order to fully implement and automate the administration processes although these additional processes are relatively well known processes in the industry (processes for trade execution, reporting etc).

Further, by assigning differently skilled resources to each process step the present invention takes into account the varying level of skills of people available in the fields of wealth management, funds management and financial planning to enable the invention to be applied to market conditions prevalent in most markets. For example, financial advisers and planners typically do not have the skills (or the legal right) to advise their clients on specific equities or even specific industry sectors. Rather, their area of expertise is in translating investor's requirements in a comprehensive financial plan and translating the financial plan into allocation across assets and/or investment styles. Similarly, asset managers are not qualified (or legally allowed) to understand particular investor's requirements and translating these into a portfolio of equities.

The preferred embodiment of the present invention uses the concept of a portfolio manager. A portfolio manager is a professional whose role is to actively manage all tiers between the asset tier (managed by the adviser) and the securities tier (tier n managed by the asset or asset manager).

A portfolio manager would typically focus on understanding industry wide trends and would be required to obtain appropriate qualifications enabling him/her to make recommendations on specific asset manager programs and recommendations with respect to allocations across several tiers. A portfolio manager would apply this understanding when collaborating with an adviser to establish a new IMA portfolio or when rebalancing individual IMA portfolios following changes to the underlying asset manager programs.

It is expected that in most cases the role of the portfolio manager would be performed by a uniquely qualified person. However, in some cases, the role of the portfolio manager could be performed by the adviser or the asset manager depending on the focus and the complexity of the multi-tiered portfolio offering in a particular market.

Further, the preferred embodiment of the invention leverages the role of an administrator. Preferably, the administrator role is mostly performed by the automation platform and may in some cases be supplemented by an actual administration resource. It is preferred that all repetitive tasks are performed by the administrator while all decision making tasks are performed by the skilled resources described previously.

An administrator should, based on the level of technology enablement available, make recommendations to support the decision making process of the skilled resource. For example, the administrator may recommend certain trade actions to be applied to a particular IMA portfolio and preferably waits for the portfolio manager to ratify the recommendation before applying the resulting trade orders to that account.

Automating the core administration processes is particularly preferred in order to enable a cost effective delivery of a multi-tiered IMA portfolio. Automating these processes reduces the administration burden on skilled resources and reduces the variable cost of delivering multi-tiered IMA portfolios. Of course, it is preferred to automate as many administration processes as possible in order to provide the greatest reduction in administration cost associated with the operation of an IMA according to the present invention.

The following are important processes that should be included in order achieve the full benefits of an IMA arrangement according to the present invention. These processes are as follows:

Application & account set-up;

Multi-tier re-balancing;

Performance review; and

Asset manager program replacement.

Application and Account Set Up

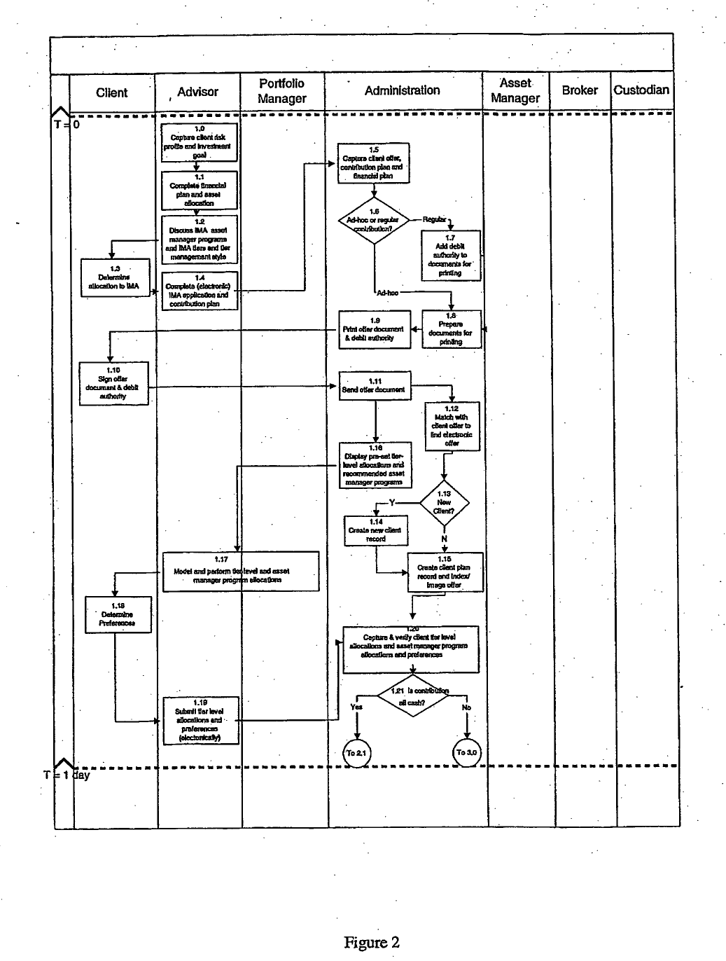

With reference to FIG. 2, the application and account set up process describes the steps involved in setting up an account for a multi-tiered IMA portfolio. Various processes of particular interest are described below. All others are described in the process flow detailed in FIG. 2.

Discuss IMA Asset Manager Programs and IMA Customisation Tiers

This particular process step (identified as item 1.2 in FIG. 2) includes collaboration required between an adviser, a portfolio manager and optionally an asset manager to introduce the adviser to each available investment option within a multi-tiered IMA offering. Any discussion is expected to include the depth and selection of tiers that the portfolio manager maintains and available asset manager programs.

The portfolio manager is likely to commence any discussion by outlining pre-set tier allocation models. Although not essential to the invention, pre-set allocation models would enhance the account setup process by addressing the majority of investor requirements with pre-determined allocation models and by having pre-selected asset manager programs that accord with standard investor requirements. For example, using our case study of industry sector based tiers, a pre-set model for aggressive growth could be heavily weighted towards the high technology industries with a set of underlying asset manager programs, one specialising in bio-technology, one in telecommunication technologies, and another in computing technologies.

Irrespective of the availability of pre-set models, the portfolio manager should explain the criteria available to the adviser on selection of each tiered allocation. In the example of industry-based tiers, the portfolio manager would be expected to provide broad economic commentary to present the criteria used to select a particular industry sector versus another. The portfolio manager would also be expected to present the selection of asset manager programs to the adviser and describe the investment style/philosophy, track record, key resources and processes and current recommended securities allocation for that program. Optionally, although not essential to the present invention, should an adviser wish to learn more about the program itself, the asset manager could be brought-in to collaborate ‘live’ with the adviser and portfolio manager.

The key automation point in this process step is the automation of the collaboration process. A collaboration platform will enable a successful consultation with an adviser. Although desirable, the collaboration does not need to be implemented by use of a data communications network (eg. Internet) and could be undertaken entirely through a voice telecommunication system such as a voice conferencing system.

Display Pre-Established Tier Level Allocation and Recommended Asset Manager Programs

This process step (identified as item 1.16 in FIG. 2) includes the administrator's task of retrieving pre-established models applicable to an investor's financial plan. The definition of pre-established allocation strategies is likely to be a manual process. The pre-established models should reflect the knowledge that the group of portfolio managers have of both industry level trends and specific asset manager programs. However, the storage and retrieval of these pre-established models is preferably automated.

Model and Perform Tier Level Allocations

This process step (identified as item 1.17 in FIG. 2) includes actual collaboration between the portfolio manager and the adviser to discuss and establish allocations of the investor's investment in the IMA across the various tiers and asset manager programs. This process step may be as simple as applying the recommended pre-established tier level allocation and associated asset manager programs or could lead to a customisation of pre-established allocation strategies.

The automation point is the collaboration environment (the passive and active management tasks are covered by process steps described below). In this instance, the collaboration environment should enable the portfolio manager and adviser to share information concerning the risks and returns of a tiered allocation. The impact on the portfolio of an investment strategy may be displayed to the portfolio manager and adviser in a variety of ways. Preferably, embodiments of the invention do not require a specific display method. Also, the modelling automation could be provided as part of an existing adviser enablement platform rather than as part of the IMA platform.

Optionally, the allocation of funds at each intermediate allocation point could be automated whereby the system would present customisation suggestions based upon inputs from the investor's financial plan. However, the adviser should always retain the responsibility of translating suggestions into actual allocations.

In a preferred embodiment, the modelling of an investor's choices tests investment outcomes against variance in market conditions, client selected allocation rules, pre-mix variations and non-IMA investments.

Determine Preferences

This process step (identified as item 1.18 in FIG. 2) enables the adviser and investor to select certain preferences related to the management of tier level allocations and asset manager programs. Preferably, there are no prohibitions with respect to specific equities so that the performance of asset manager programs is maintained. In this respect, prohibitions and preferences are preferably applied to any of the (n−1) tiers (ie tiers other than asset manager programs). For example, an investor's preference not to invest in Philip Morris for ethical reasons, would be indicated as a preference not to allocate any funds to a tobacco asset manager program (should one be available).

Preferably, the advisor and/or investor are able to select the management style applicable to tier level allocations. In the preferred embodiment, the adviser (and investor) will be able to select either passive or active management.

Passive Management:

In this mode, the tier level allocation is set at the time of creation of the IMA portfolio and would only be reviewed and changed upon direct order by the adviser (or investor) such as following an end-of-year review. Therefore, the portfolio manager would not actively rebalance the portfolio at each tier during the period. However, the process requires the tiers to be periodically re-valued and the adviser to be notified by the portfolio manager when large differences occur between original allocations and actual allocations.

Active Management:

In this mode, the tier level allocation philosophy will be actively maintained by the portfolio manager until a change order is provided by the Adviser (or investor). Active management requires the portfolio manager to sporadically or periodically review the actual allocation across tiers resulting from changes in the underlying securities and asset manager programs. Where variances between an allocation strategy and the actual results of the holdings at the time of review is greater than a predetermined limit, the portfolio manager should take action to re-establish the original allocation philosophy. Active management is not intended to maximise performance but is proposed to maintain investor preferences.

Active management will enable the maintenance of philosophies such as maintenance of allocation percentages across tiers or maintenance of specific investment mandates such as growth focused, income focused, tax focused, capital guarantee, or a combination of these. Therefore, the information captured in this process needs to cover starting allocation percentages, the selected philosophy for each particular tier, and the selected limit for a given philosophy. The limit is expressed in percentage deviation from original philosophy and is used to avoid triggering an event where the deviation is part of a normal trend for that tier.

It is expected that the majority of all active management styles would use the pre-established allocation percentages philosophy. More complex investment philosophies such as growth versus income would actually be managed at the asset manager program level whereby a program could be focused on income and another on growth and the tier level active management would maintain the percentage allocation across these.

For the purpose of illustration, with a percentage allocation philosophy where the original tier level allocation is split 50% towards a banking specialised asset manager program and 50% towards a biotechnology specialised asset manager program, and where a review of valuation of the securities underlying each program results in the banking program being only 30% of the total allocation, then, working with an active management style mandate, the portfolio manager would ‘sell’ enough securities from the bio-technology program to ‘buy’ the required securities to re-establish the banking program to 50% of total investment value.

In the preferred embodiment, this process step is not automated other than for the step of capturing preferences and prohibitions in the administration system.

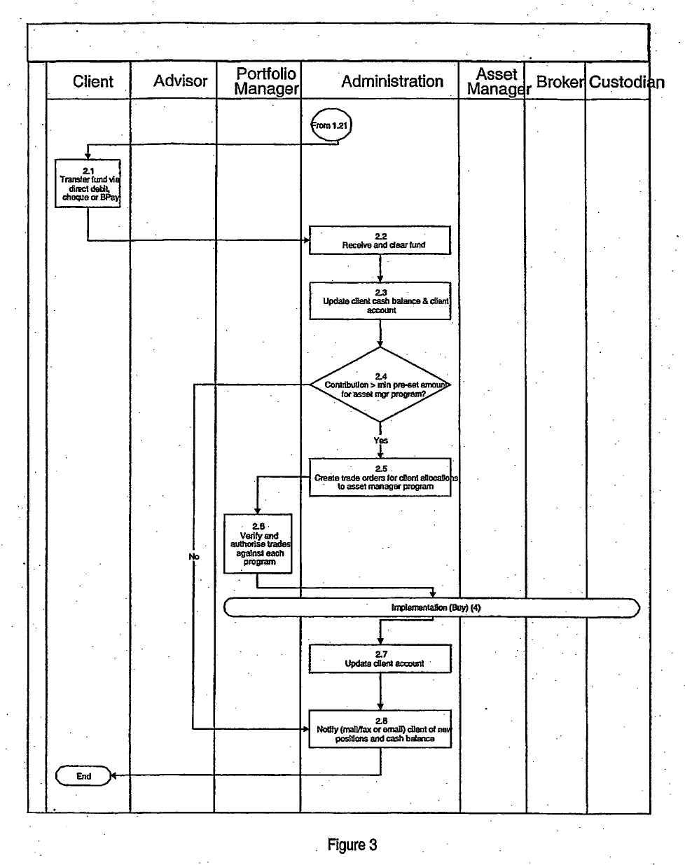

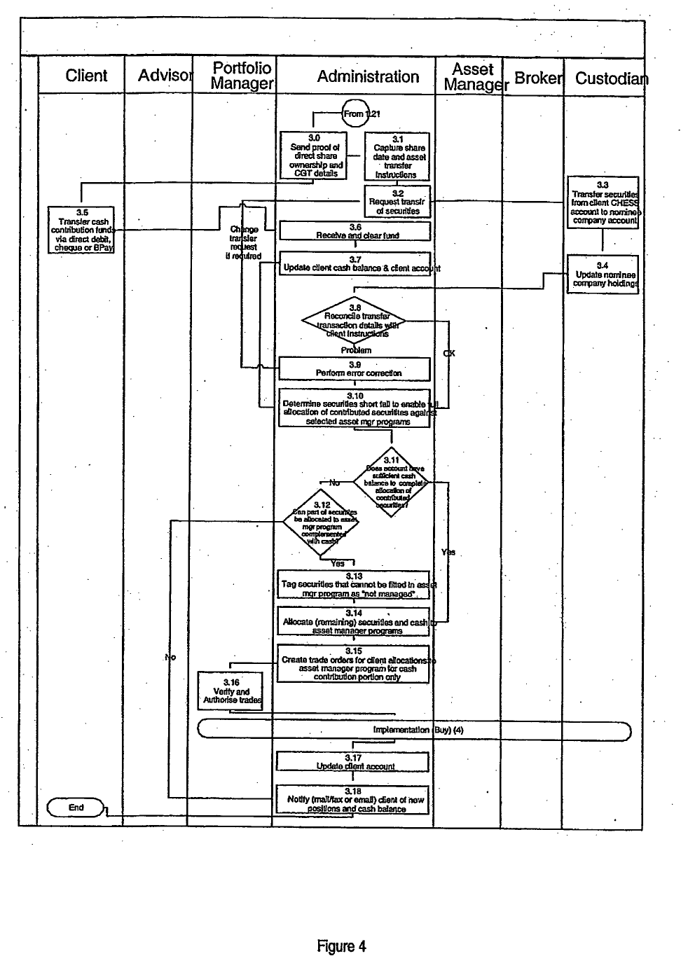

Included in the application and account set up process is the contribution processes which differ depending on whether the contribution is in cash or in kind (eg securities). Details of the individual steps included in this process is illustrated in FIGS. 3 and 4.

Whilst the individual steps detailed in FIGS. 3 and 4 are relatively self explanatory, with reference to step 3.1, it is expected that instructions for managing a direct share contribution to a client's account will include details of share parcels. In this respect, the envisaged options are:

1. Exclusive Holding—administration system will disregard the holding when performing reconciliation or re-balance and the client must provide instructions if they are going to be sold;

2. Partial Holding—option to flag specific parcels to be included in a reconciliation or re-balance; and

3. Inclusive Holding—the holding will be incorporated into a reconciliation

Although the application and account set up process may be implemented without the use of a data communications network, in a particularly preferred embodiment, a data communications network such as the Internet is used to effect communication between an investor and their financial advisor. Similarly, should an advisor wish to learn more about a program, a data communications network may also be used to effect communication between an asset manager and an advisor and/or portfolio manager. In a preferred embodiment of the invention, each individual involved in the process of preparing and submitting an application and establishing an account is equipped with a communications device that is connectable as a node to a data communications network. In this respect, the communication device may be in the form of a personal computer, a personal digital assistant or a mobile telecommunications device executing appropriate computer instruction code such that the device may connect to a data communications network and effect communication between any one or more of the individual operators.

Whilst communication between individual operators may be effected by ad-hoc connection of a device to a data communications network as and when required, in a preferred embodiment of the invention, other processes such as rebalancing of an individual's investment portfolio is preferably effected on an internal computing resource that is appropriately sized for the task of rebalancing the investment portfolio of many account holders. In one particular embodiment, the computing means used to monitor and rebalance accounts is the internal computing resource of an investment administrator that is suitably sized to effect rapid rebalancing of all accounts monitored and maintained by that computing system. The investment administrator may be an investment bank providing administration services to the portfolio manager, asset manager and/or adviser.

Further, the computing network of the investment administrator preferably provides external access to approved external financial advisors enabling those advisors to obtain information relating to the accounts of their clients. In addition, the provision of external access to advisors enables them to alter their client's selections and customisation within the multiple tier structure thus effecting a change to the pre-defined rules by which rebalancing and investment allocations are effected.

In this particularly preferred embodiment, asset managers acting externally to the investment administrator are also provided with external access thus enabling them to provide information to the computing network internal to the investment administrator relating to the valuation of securities under the asset manager's control. The provision of access to the data communications network also provides for the issuance of instructions from the administrators internal computing network to external asset managers with respect to buy and/or sell instructions to be effected by the asset manager or to be approved after possible alterations by the asset manager and effected by the administrator through direct interconnectivity with a broker or custodian in the name of the asset manager. Similarly, portfolio managers may act externally from the investment administrator and may also be provided with access to the administrators data communications network in order for the portfolio managers to perform their duties.

The task of rebalancing the accounts of a relatively large number of individuals will require the execution of rebalancing algorithms that will perform a set of iterations starting from the lowest tier and gradually working through the rebalancing process moving up through the tiers to eventually perform a rebalancing of a portfolio. It is expected that a rebalancing task for a relatively large number of individuals will result in a substantial computing demand and the computing resource that performs the rebalancing task for account holders should be capable of performing a rebalancing task within a relatively short period of time in order to provide regular up to date information to advisors and investors.

Multi-Tier Re-Balancing

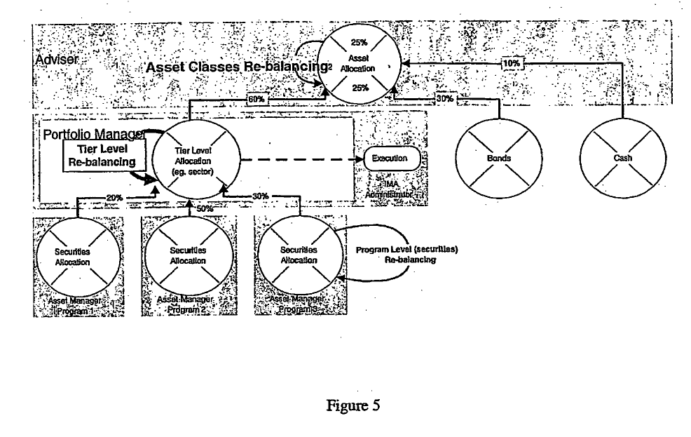

Rebalancing a multi-tier IMA portfolio is substantially more complex than rebalancing a single tier portfolio comprising securities. With reference to FIG. 5, there are three levels of rebalancing that may occur:

Asset Class Level Rebalancing

At the asset level, the adviser would review and where required rebalance an investor's investment portfolio typically following a periodic review schedule. Automation of this process may occur.

Asset Manager Program Level (Securities) Rebalancing

The asset manager will actively manage all securities under his/her control. Therefore, decisions made by the asset manager can be made in isolation of any knowledge of the actual funds allocated to the particular program or the number of accounts affected by the asset manager's decisions with respect to their particular program. Furthermore, the act of rebalancing is preferably executed by the administrator using a technique called “bulking of orders” and where legally permissible “netting of orders”.

Bulking of orders is particularly preferred as it enables buy/sell orders to be grouped at the IMA administrator level and executed simultaneously. This would be likely to occur once a day.

Netting of orders would enable the administrator to net one buy order for a sell order of the same security. Netting of orders allow further cost efficiencies to be realised.

Asset managers rebalance securities at the program level as many times as required to maintain target performance. Rebalancing at this level may occur regularly or sporadically as a result of market-events. Executing a rebalance may also assist making intra-day decisions. Execution of asset manager program rebalancing actions are preferably not performed until tier level rebalancing has been performed or determined not to be applicable.

Tier Level Rebalancing

As asset managers rebalance their programs and as underlying securities fluctuate in value, the actual allocation of funds across tiers is likely to change from the initial allocation. Furthermore, changes across tiers may have compounding influences in the final allocation and/or philosophy behind an investor's decision to put monies in an IMA portfolio.

As described above, the tier level allocation can be either passively managed (ie reported upon but without actions taken) or actively managed (ie reviewed and executed).

Tier level rebalancing is applicable where portfolio managers are required to actively manage tier level allocations. Tier level rebalancing may be triggered by either a periodic review of the IMA portfolio by the portfolio manager (which is expected to happen no more than monthly) or by a limit based trigger. Limit based triggers could be issued from the impact of changes in the valuation of the investor's IMA holding with respect to a number of variables such as percentage allocations to asset manager programs, percentage allocations to tiers, level of imputation, volatility, etc.

The process steps described below are included as part of the active management of tier level allocations. All other process steps are described in the process flow illustrated in FIG. 5 where each level of automation is also identified.

Re-Value IMA Portfolio

This process step covers the task of re-valuing the investor's IMA holding. The result of this process step is not only an IMA portfolio level valuation update, but also a review of the valuation at all tiers. The valuation process would be triggered periodically to match the asset managers' periodic rebalancing with a minimum monthly update frequency and maximum daily frequency. The valuation update is based on end of day prices for securities held and is preferably fully automated.

Report Valuation Changes Impact for n−1 Tiers

This process step includes the task of reviewing the impact of valuation changes for each tier but excludes valuation of securities as actions taken at the securities level is under the control of the asset manager. For each tier, starting with tier n−1 and ending with tier 1, the administration system preferably provides a report to the portfolio manager including the following:

Total Value of Tier including Weightings of Sub-Tiers

If a valuation is performed for an industry (eg. financial services) level tier, the report preferably also shows the allocation against each industry sector (eg. banking and insurance) within that industry.

Historical Performance

This report provides an indication of the volatility and tax impact (over the life of the investment or since last review, whichever is shortest) applicable to that tier.

Tax Events Triggered by Movements in the Underlying Tiers Since Last Rebalancing

A detailed report considering tax events triggered by changes in the underlying asset manager program is preferably provided when reporting the (n−1)th tier.

Define Required Action at n−1 Tiers

This process step includes the task of defining the action required by the portfolio manager, on behalf of the investor, in order to reduce variances with respect to the actual allocation of funds as compared with the established rules for intermediate allocations. The portfolio manager preferably uses the administration system to model the impact of actions on the total portfolio. For each tier, starting with tier n−1 and ending with tier 1, the administration system preferably displays an alarm detailing the performance criteria that falls outside the given tier limit. For example, where the industry tier is actively managed using a percentage allocation philosophy (50% towards banking and 50% towards bio-technology) and where that tier has a 20% limit (ie more than 20% of tier value lies outside original allocation percentages), an alarm would be triggered as 40% of the total tier value does not fit within the original allocation (ie banking is worth 30%, bio technology is worth 70%, or 40% more than its intended allocation when compared with the lowest value sub-tier-banking). The alarm preferably displays the management philosophy, the tier limit and the level of deviation.

Recommended Action

The recommended action for each tier is the translation of allocation changes required to maintain the selected philosophy for that tier into securities buy and sell orders. Preferably, all orders would be to proportionally buy or sell all of the securities of the tiers immediately below the tier under consideration. For example, when reviewing tier (n−1) the orders would be proportionally allocated to the asset manager programs allocated to that tier. In other words, the recommended actions will not impact the allocations within lower level tiers (eg. individual asset manager programs) but will impact the total value allocated to those lower level tiers. Preferably, no recommended action would be reported if an alarm has not been triggered for that tier. Based on the valuation changes impact report, the portfolio manager will then be able to select whether to apply the recommended action for that tier or to ignore the system's recommendation. Should the portfolio manager select to apply the recommended action, the system would then issue a “simulated” valuation changes impact report reflecting the changes suggested and their impact on higher-level tiers. The portfolio manager would then recommence the process of reviewing the recommended action but for the next tier and this time based on the “simulated” valuation changes. This process step is complete when the portfolio manager has reviewed recommendations for all tier 1 allocations.

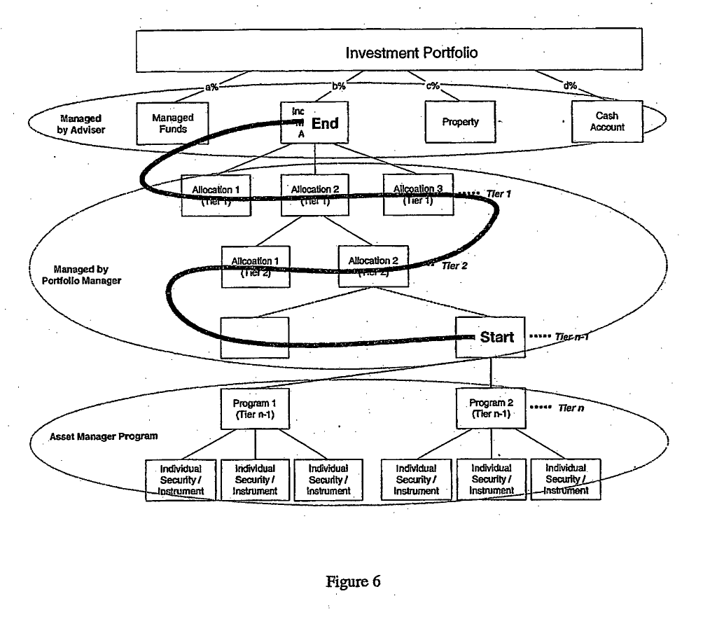

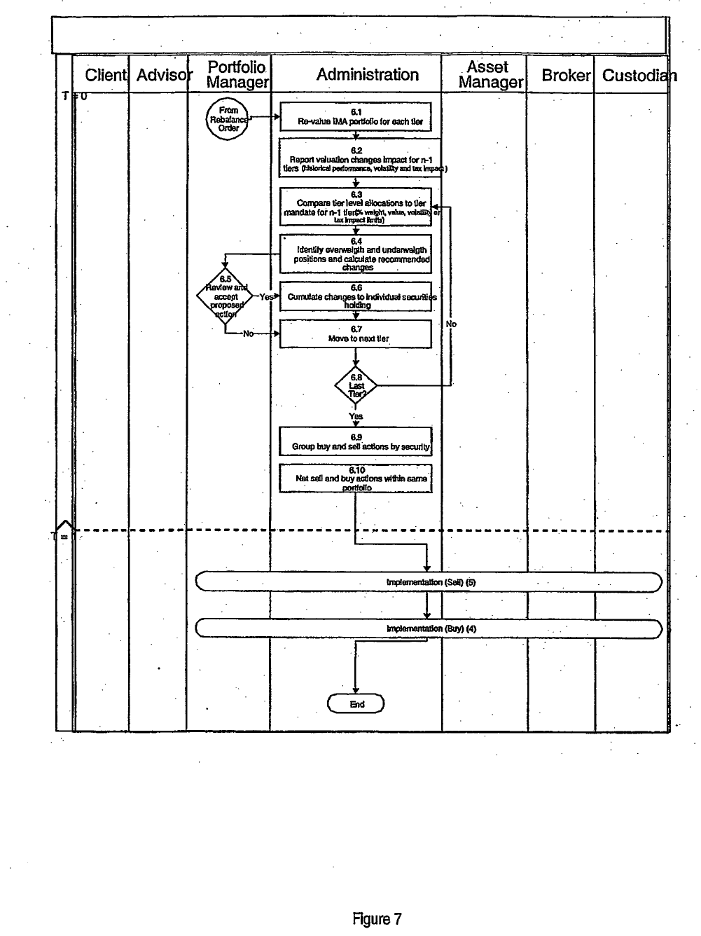

It is particularly preferred that the portfolio manager have the ability to overrule the system's recommendations thus enabling active management. Based on knowledge of the industry, the portfolio manager may decide that an investor would be better served by ignoring market events that are considered to be short term and hence ignoring proposed recovery actions in relation to those market events. In all instances, the portfolio manager makes the final decision while the administration system provides decision support and automates the process. A tier level rebalancing decision path is illustrated in FIG. 6 and a multi-tier rebalancing process flow chart is illustrated in FIG. 7.

Group and Net Actions

This process step includes the task of grouping all actions taken by the portfolio manager by security within each IMA portfolio. Buy and sell actions within a particular IMA portfolio for a particular security are then “netted out” in order to reduce trading costs and reduce the impact on the IMA portfolio's tax position.

Performance Review

The performance review process describes the steps executed by advisers (sometimes with assistance from portfolio managers) in reviewing the IMA portfolios under their management. Based on the review results and individual investors situation (i.e. investment profile and objective), it may be necessary to implement some actions to re-establish or modify the original allocation philosophy.

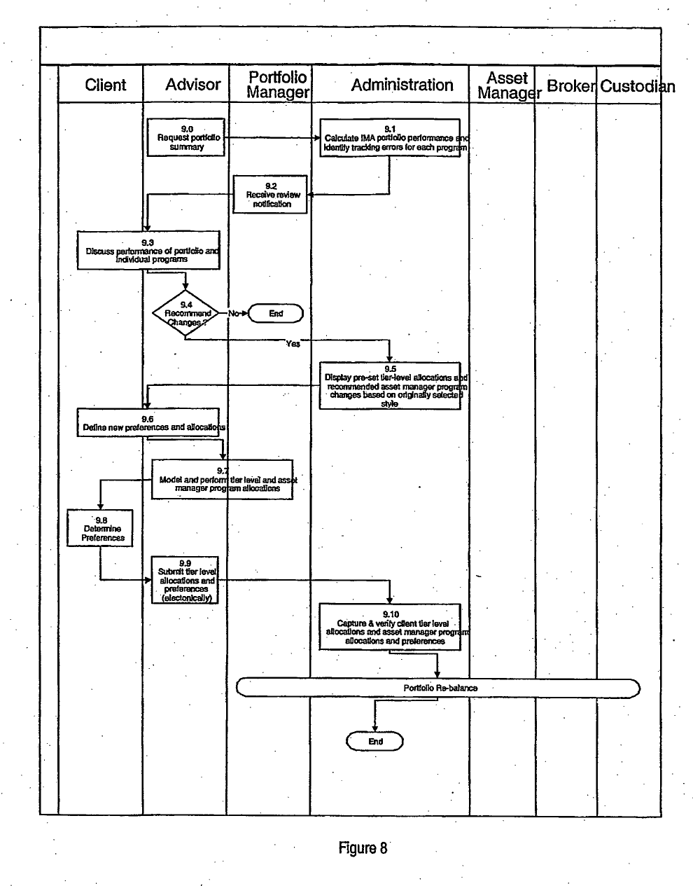

With reference to FIG. 8, a process flow chart detailing the steps in conducting a performance review is illustrated. Various of those steps are described below.

Review IMA Portfolio Performance and Identify Tracking Errors

This process step includes the task of reviewing the overall performance of a multi-tier IMA portfolio and comparing it with the performances of all underlying asset manager programs (at tier n) to identify any tracking errors that may have been created during the multi-tier re-balancing process. Performance of each underlying asset manager program is also reviewed. For each asset manager program, the administration system preferably provides a report to the adviser and portfolio manager including the following:

List of all Changes Registered for the Asset Manager Program

Such a list can be compared to transaction history of the portfolio to identify tracking errors.

Comparison of asset manager program performance against specified index

This comparative figure allows the advisers/portfolio managers to compare the asset manager's performance against the market. For example, if an asset manager program returns 10% and the sector it is representing has an indexed return of 5%, that particular asset manager is performing above industry average.

Housekeeping Information

Housekeeping information such as management fee, number of transactions triggered by the asset manager program should also be provided and considered as part of the performance review of asset managers.

As described in the section entitled Multi-tier Re-balancing, the administration system preferably also provides portfolio managers and advisers with a report for each IMA portfolio tier including the tier level allocation value and weightings, historical performances and tax events triggered by each asset manager program change.

Define New Preferences and Allocations

This process step includes the task of defining required actions to capture new investor preferences and maximise the overall performance of the multi-tiered IMA portfolio. Firstly, a portfolio manager will need to capture the investor's new preferences. For example, if a new prohibition has been placed on a particular sector, the allocation to that sector will need to be liquidated. Then the portfolio manager will aim to maximise performance by:

Replacing Under-Performing Asset Managers

Each asset manager program represents a unique investment style and provides coverage of a specific sector (e.g. finance industry or banking sector within the finance industry). Since there may be multiple asset manager programs specialising in the same sector with similar investment management style, asset manager programs more closely matching the investor's criteria of performance and volatility could replace the incumbent programs.

Change Allocation Across Tiers

The portfolio manager leveraging his/her knowledge of industry trend and the asset manager programs would be able to make recommendations on the tier level allocation to better match the tier level allocation to the investor's financial plan (e.g. reduce volatility).

Once a portfolio manager has defined the new tier level allocation in the administration system, a simulation on the impact to the total portfolio should be generated for the portfolio manager to review and make any necessary adjustments to the recommendation.

Asset Manager Program Management

Asset manager program management determines the number of asset manager programs required to support the IMA service offering. Depending on the type of investors targeted and hence the degree of customisation (for example, customers with smaller investments will be offered IMA service with minimal customisation whereas customers with larger investments will likely be offered a more flexible service) determines the number of tiers and hence the number of asset manager programs and asset managers required to support the service offering.

For the purpose of illustration, consider an IMA service that only offers customisation on global market preferences. Investments are allocated across several global markets focused asset manager programs. This is a two tier IMA portfolio. If the IMA service is expanded to allow investors to specify their industry preferences, a third tier (by industry type) is added below the global market tier.

The asset manager programs are now required to specialise in one industry for each global market. The number of programs required will also increase to provide a full coverage of all industry types for all global markets. The asset managers will also need different skill sets to manage the more specialised programs. As more customisations (intermediate allocations) are provided, the number of tiers and asset manager programs increases exponentially.

Conclusion

The system and method of the present invention embody many advantages as compared with the current approaches in relation to IMAs.

Provision of Highly Customised IMAs at Relatively Low Cost

In particular, the present invention enables investors to initially allocate funds for investment according to pre-determined rules and to maintain the allocation of funds according to those rules over time.

The intermediate allocation of funds according to the present invention enables a manager without the skills and expertise of an asset manager to manage the allocation process. Use of lower skilled operators for management of the allocation process reduces the overall costs associated with establishing and monitoring an investment of funds with a relatively high level of customization with respect to investment choices.

The use of a system and computer program to actively administer the allocation process greatly increases the number of customers that can be actively managed by the portfolio manager, thereby reducing the administration costs.

Continuous Active Management by Third Party

A multi tiered portfolio arrangement according to the present invention allows active management to extend beyond the confines of an asset manager program. Each tier of allocation can also be actively managed by an appropriately skilled professional who does not require the same expertise as an asset manager and only needs to understand the relative performance of industry sectors.

Access to Sector Depth Beyond that Possible Through Mutual Funds

Sector based mutual funds (particularly in highly concentrated sectors) usually cover only the largest stocks in a sector, and may therefore not represent the profile of the sector. For example, in particular sectors larger companies typically have a very different operational and risk profile than smaller, more research focussed companies. A multi-tiered portfolio arrangement according to the present invention allows an asset manager to offer multiple specialised exposures to a particular sector leaving the investor to select the appropriate level of exposure to sector depth through a tiered allocation in that sector

Accurate Tracking of Professional Manager's Performance

A multi-tiered portfolio arrangement according to the present invention also allows individual investor customisation by covering specific investor requirements within a portfolio's allocation across all n tiers. Customisation in this form is provided without directly affecting individual securities actively managed within asset manager programs. As a result, the asset managers' performances remain accurately reflected in the investor's overall portfolio. This effectively enables tracking errors, that would otherwise occur, to be eliminated.

1-14. (canceled)

15. A funds investment system for managing funds that have been allocated to a plurality of asset manager programs through a plurality of intermediate allocations, the most subordinate allocations representing the allocation of funds to an asset manager program with all superior intermediate allocations effected external to any asset manager program, with each intermediate allocation of funds according to a predefined rule, the system including:
a receiving means for receiving data relating to the value of funds held by the plurality of asset manager programs;
a calculating means for determining the value of intermediate allocations that would have led to the distribution of funds to individual asset manager programs according to the value data received;
a comparison means for comparing the determined intermediate allocations with the predefined rules for same; and
the calculating means determining a new allocation of funds to asset managers in accordance with the predefined rules for intermediate allocations in the event that a variance greater than a predetermined amount exists between the determined intermediate allocation and the predefined rules for same.

16. A funds investment system according to claim 15 wherein the determined new allocation of funds distribution to asset managers is provided to a user by a data output means thus reporting the new distribution required to maintain the integrity of the pre-defined intermediate allocation rules.

17. A funds investment system according to claim 15 wherein a data input means is operated by the user to request a calculation to determine the options that are available to effect the new allocation of funds.

18. A finds investment system according to claim 17 wherein the selection of an option and effecting the transfer of funds between asset managers to accord with the new distribution is automated.

19-21. (canceled)

22. A computer program embodied on a computer readable medium for managing funds that have been allocated to a plurality of asset manager programs through a network of intermediate allocations, the most subordinate allocations representing the allocation of funds to an asset manager program with all superior intermediate allocations effected external to any asset manager program, and where each intermediate allocation accords with a pre-defined rule wherein said computer program includes computer instruction code for executing tasks including:
code for receiving data relating to the value of funds held by the plurality of asset manager programs;
code for determining the intermediate allocations that would have led to the distribution of funds to individual asset manager programs according to the value data received;
code for comparing the determined intermediate allocations with the pre-defined rules for same and determining whether a variance greater than a predetermined amount exists between the determined intermediate allocation and the pre-defined rules for same; and
code for calculating a new allocation of funds to asset managers in accordance with the predefined rules for intermediate allocations.

23. A computer program according to claim 22 wherein the computer program further includes computer instruction code for reporting the calculated new allocation of funds.

24. A computer program according to claim 23 wherein the computer program further includes computer instruction code for receiving an instruction from a user to effect a transfer of funds to each most subordinate allocation to accord with the calculated new allocation.

25. A computer program according to claim 23 wherein the computer program further includes computer instruction code for transferring funds to accord with the new allocation.

26. In a data communications network including communication devices enabling communication between a user and a funds investment system, a method of investing funds with asset manager programs by distributing total funds available for investment to a plurality of asset manager programs said distribution effected by performing the method step of performing a plurality of intermediate allocations through a network of allocations, the most subordinate allocations representing the allocation of funds to an asset manager program with all superior intermediate allocations effected external to any asset manager program, each intermediate allocation according with predefined rules supplied to the system by the user over the communications network and repeating the step of performing intermediate allocations until all available funds are allocated with asset manager programs.

27. A method according to claim 26 wherein the communication devices used by the user include any one or more of the following:
a laptop personal computer;
a notebook personal computer;
a wireless laptop personal computer;
a wireless notebook personal computer;
a cell phone; or
a cell phone having connection facilities to the data communications network.

28. A method according to claim 26 wherein the predefined rules for intermediate allocations are established to apportion funds according to an investor's preferred distribution of investment funds to particular assets or classes of assets.

29. A method according to claim 26 wherein the intermediate allocations form a network of allocations and an intermediate allocation receives an apportionment of funds from a superior allocation and apportions funds to a subordinate allocation.

30. In a data communications network including communication devices enabling communication between a user and a funds investment system, a method of investing funds with asset manager programs by distributing total funds available for investment to a plurality of asset manager programs through a network of allocations, the most subordinate allocations representing the allocation of funds to an asset manager program with all superior intermediate allocations effected external to any asset manager program, said distribution effected by performing the method step of performing a plurality of intermediate allocations each intermediate allocation according with predefined rules supplied to the system by the user over the communications network and repeating the step of performing intermediate allocations until all available funds are allocated with asset manager programs:
wherein the method includes the step of receiving from asset managers, to whom funds have been allocated, a valuation of the invested funds in each of the asset manager programs and determining a value at each superior intermediate allocation, the value being determined from valuations at subordinate allocations.

31. (canceled)

32. A method according to claim 30 wherein the valuation of intermediate allocations occurs periodically.

33. A method according to claim 30 wherein the valuation of intermediate allocations occurs as a result of a redefined trigger.

34. A method according to claim 33 wherein the predefined trigger is a value of funds with an asset manager program exceeding a predetermined amount.

35. A method according to claim 30 wherein the valuations of the intermediate allocations may be compared with the predefined allocation rules to determine the extent of variance with respect to those rules.

36. A method according to claim 30 wherein the method includes rules relating to the allowable variance of allocation valuations as compared with the predefined rules regarding intermediate allocations and in the event that the allowable variance is exceeded, a warning is provided.

37. A method according to claim 36 wherein the allowable variance is exceeded and the method includes the generation of recommended actions for the distribution of investment funds in order to bring the distribution of funds into agreement with the pre-defined allocation rules.

38. A method according to claim 37 wherein the recommended actions include the provision of recommended buy and sell orders with respect to particular securities.

39. A method according to either claim 37 wherein the method includes the step of providing a simulated valuation of the intermediate allocations and the funds invested with individual asset manager programs that would most likely result from executing the recommended actions.

40. In a data communications network including communication devices enabling communication between a user and a funds investment system, a method of managing invested funds that have been allocated to a plurality of asset manager programs through a network of intermediate allocations, the most subordinate allocations representing the allocation of funds to an asset manager program with all superior intermediate allocations effected external to any asset manager program, with each intermediate allocation according with a predefined rule communicated to the system by the user, the funds investment system performing the method steps of:
obtaining data relating to the value of funds allocated to the plurality of asset manager programs;
calculating the intermediate allocations that would have led to the distribution of funds to individual asset manager programs according to the value data obtained;
comparing the calculated intermediate allocations with the pre-defined rules for same; and
in the event that a predefined variance between the calculated intermediate allocation and the predefined rule for same is exceeded, calculating a new allocation of funds to asset managers in accordance with the pre-defined rules for intermediate allocations.

41. A method according to claim 40 wherein the requirement to perform a new calculation of funds distribution to asset managers is communicated to the user as warning that action is required to maintain the integrity of the pre-defined intermediate allocation rules.

42. A method according to claim 40 wherein the funds investment system determines the options available to effect the new distribution of funds and communicates same to the user for consideration.

43. A method according to claim 42 wherein the user selects at least one of the available options and communicates the selection to the funds investment system, said funds investment system upon receiving said selection effecting transfer of funds to effect the new distribution of funds.

44.-65. (canceled)

66. A funds investment system according to claim 15 wherein the intermediate allocations are grouped to define categories of allocations said categories being individually managed by a computing means in operable communication with the calculating means such that the computing means receives data relating to the amount of funds allocated to each intermediate allocation and/or each allocation category.

67. A computer program embodied on a computer readable medium according to claim 27 wherein intermediate allocations are grouped to define categories of allocations, the computer program including code for reporting the amount of funds allocated to each intermediate allocation and/or allocation category thus enabling the allocation categories to be individually managed.

68. A method according to either claims 40 wherein intermediate allocations are grouped to define categories of allocations, the method including the step of reporting the amount of funds allocated to each intermediate allocation and/or allocation category thus enabling the allocation categories to be individually managed.
